(19) United States
(12) Patent Application Publication
(10) Pub. No.: US 2004/0192106 A1
(43) Pub. Date: Sep. 30, 2004

(54) Latching device for a battery pack module

(76) Inventor: Rory Britz, Kaufering (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/807,893

(22) Filed: Mar. 24, 2004

(30) Foreign Application Priority Data
Mar. 25, 2003 (DE) 103 13 187.6

(51) Int. Cl. H01R 33/945

(52) U.S. Cl. 439/577

(57) ABSTRACT

A battery pack module (2), which can be inserted into a housing part (1) of a powered hand tool along a direction of insertion (A), having two latching hooks (5) with at least one leaf spring (4) and outwardly spring-biased, arranged on opposite sides of a module housing (3) and oriented transverse to the direction of insertion (A), which are connected to finger pressure surfaces (6) that can be moved from a resting position (I) into a released position (II). At least one leaf spring (4) is configured biconvex and forms a local force maximum (11) between the resting position (I) and the released position (II).

### BACKGROUND OF THE INVENTION

The invention relates to a latching device for a battery pack module, which preferably is insertable into an electrically powered hand tool machine such as a combination hammer, screwing drill, etc.

According to EP 1069630 and U.S. Pat. No. 5,213,913, a battery pack module that is insertable into a housing part of a powered hand tool machine has two outwardly oriented spring-biased latching hooks arranged on opposite sides transverse to the direction of insertion that can be compressed between two fingers of the one hand. A constant high force must be applied by the fingers in the unlatched, compressed release position by virtue of the essentially linear spring characteristic of the flat leaf springs. There is no tactile feedback relative to releasing. In addition, the leaf springs are connected with the module housing outside of the longitudinal zone of the finger pressure surfaces, whereby a short, wide leaf spring is required, which has only a small-area surface zone.

In addition, according to EP 582729, non-linear spring elements in locking mechanism is disclosed. According to DE 19903263, a closure system for a flap cover has a biconvex shaped leaf spring. According to U.S. Pat. No. 4,990,731, a pushbutton switch has a tactile and audible operation when a leaf spring clicks.

### SUMMARY OF THE INVENTION

The object of the invention is to provide an ergonomic latching device for a battery pack module.

This object is achieved in accordance with the invention by a battery pack module that is insertable into the housing part of a hand tool machine longitudinal to its direction of insertion that has two leaf springs arranged on opposite sides of the module housing and is oriented transverse to the direction of insertion of the battery pack module. At least one of the leaf springs has outwardly oriented latching hooks that are connected to finger pressure surfaces, which can be pressed with two fingers from a resting position to a released position, wherein at least one leaf spring is configured biconvex and forms a local maximum force between the resting position and the released position.

A non-linear spring characteristic is produced by virtue of the biconvex configuration, upon a deformation of the leaf spring resulting from the buckling behavior, which inevitably forms a local force maximum in front of a degressive curve part having a local force minimum. Accordingly, the holding force required in the released position is less than the force required at the time of the transition from the resting position to the released position, whereby the fingers are perceptibly relieved. In addition, the attainment of the released position by the perceptible engagement of the latching hook (click-pressure point) perceived by the operator after overcoming the local stiffening is a feedback noted by the user.

Advantageously, the released position is configured energetically unstable; that is, the associated potential has no local energy minimum, whereby the latching hook is automatically driven back to the resting position notwithstanding the reduced retaining force.

Advantageously, the leaf spring comprises low-damping or thin spring steel, whereby the degressive transition from the resting position to the released position the leaf spring generates a clearly audible click-sound.

Advantageously, both latching hooks are each connected with a biconvex configured leaf spring of identical spring characteristics, whereby the module housing can be intermediately switched for force transmission between the two leaf springs.

Advantageously, the leaf spring extends over the longitudinal zone of the finger pressure surface, whereby this longitudinal zone can be used for creating a large-area biconvex surface to increase the digressive curve part.

### BRIEF DESCRIPTION OF THE INVENTION

The invention will be explained in more detail with reference to the drawings, wherein:

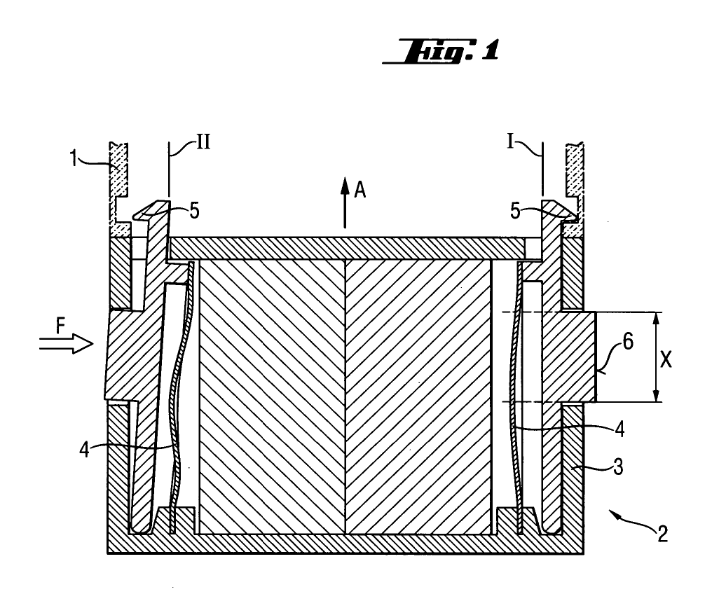

FIG. 1 shows a battery pack module according to the invention;

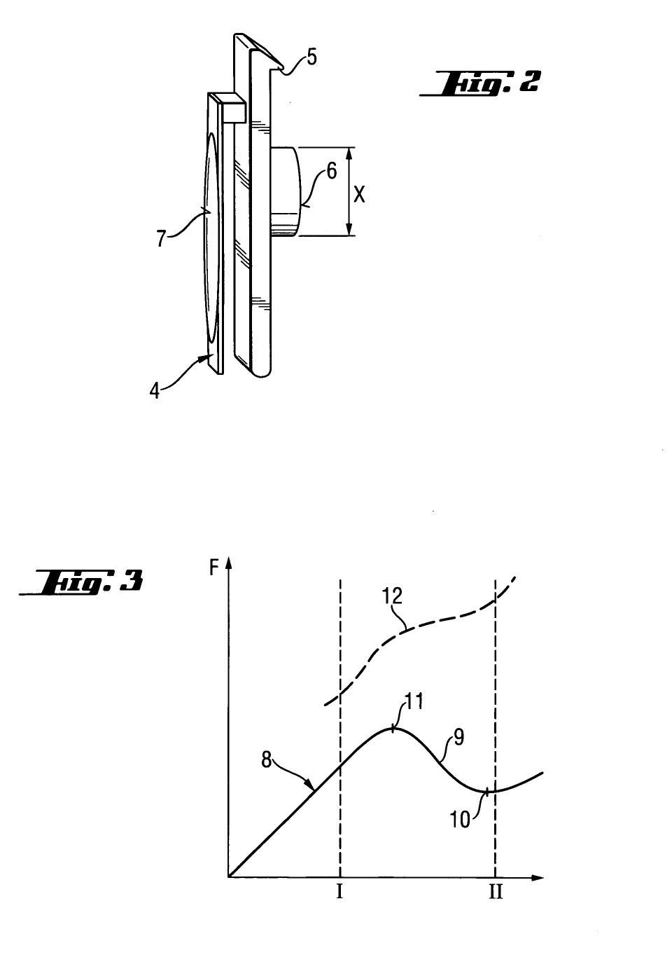

FIG. 2 shows a more detailed diagram of the spring of FIG. 1; and

FIG. 3 shows a spring characteristic according to the invention.

### DETAILED DESCRIPTION OF THE INVENTION

FIG. 1 shows a battery pack module 2 inserted longitudinal to a direction of insertion A into a housing part 1 of a hand tool machine (not shown) having two leaf springs 4 arranged on opposite sides of a module housing 3, oriented opposite each other and transverse to the direction of insertion A, said leaf springs 4 comprising thin spring steel, outwardly spring-biased latching hooks 5 with finger pressure surfaces 6. The right latching hook 5 is in the resting position 1, the left latching hook 5 is in the released position II. The respective leaf spring 4 that is unilaterally connected with the module housing 3 extends over a longitudinal zone X of the finger pressure surfaces 6.

FIG. 2 shows the bi-convex leaf spring 4 configured with a large area, bi-convex surface 7, extending over a longitudinal zone X of the finger pressure surface 6 of the latching hook 5.

FIG. 3, shows each biconvex leaf spring in the force-flexure diagram 8 between the resting position I and the released position II forming a degressive curve part 9 with a local force minimum 10 and a local force maximum 11, whereby the associated potential 12 runs monotonically and accordingly does not have a local energy minimum.

What is claimed is:

1. A battery pack module that can be inserted into a housing part (1) of a powered hand tool along a direction of insertion (A), having two latching hooks (5) with at least one leaf spring (4) outwardly spring-biased arranged on opposite sides of a module housing (3) and oriented transverse to the direction of insertion (A),which are connected to finger pressure surfaces (6) that can be moved from a resting position (I) into a released position (II), wherein at least one leaf spring (4) is configured biconvex and forms a local force maximum (11) between the resting position (I) and the released position (II).

2. The battery pack module of claim 1 wherein the released position (II) is energetically unstable.

3. The battery pack module of claim 1, wherein the leaf spring (4) is low-damping.

4. The batter pack module of claim 3, wherein each of the two latching hooks (5) are connected with a leaf spring (4) of identical spring characteristics.

5. The battery pack module of claim 4, wherein the leaf spring (4) extends over a longitudinal zone (X) of the finger pressure surface (6).
